(19) United States
(12) Patent Application Publication
(10) Pub. No.: US 2006/0263265 A1
(43) Pub. Date: Nov. 23, 2006

(54) Blood micro-separator

(76) Inventors: Der-Ren Kang, Taoyuan (TW); Gwei-Chu Yang, Taoyuan (TW); Ker-Jer Huang, Taoyuan (TW); Chih-Chun Chan, Taoyuan (TW); Hsien-Ming Wu, Taoyuan (TW)

Correspondence Address: J C PATENTS, INC., 4 VENTURE, SUITE 250, IRVINE, CA, 92618, US

(21) Appl. No.: 11/135,849

(22) Filed: May 23, 2005

(51) Int. Cl. B01L 3/00

(52) U.S. Cl. 422/101

(57) ABSTRACT

A micro-separator for separating red blood cells from blood serum in a blood sample is provided. The main mechanism driving the separation of the blood sample is centrifugal force. With physical mechanisms including surface tension and functional microstructures, the red blood cells and the blood serum in a small volume of blood (about 25 micro-liters) are separated. The entire micro-separation apparatus is disposed on a disk-shaped structure. The micro-separator can integrate with other micro-devices such as micro-mixers, micro-distributors or micro-reactors to form a fully functional apparatus. Combining the rotary driver of a CD player and an optical inspection device with a signal processing system, an inexpensive, fully automatic, parallel-processing inspection system is produced. The micro-separator has a simple structure with no movable components, and its separation mechanism does not depend on either filter papers or micro-pore structures so blockage is prevented and it can easily combine with other microfluidic devices.

### BACKGROUND OF THE INVENTION

1. Field of the Invention

The present invention relates to a micro-separator for separating blood serum from red blood cells in a blood specimen. The present invention is designed on a round disk similar to a compact disk (CD), utilizing centrifugal force driven by a rotating mechanism in an apparatus such as CD-ROM player, and a valve formed by surface tension between fluid and fluid carrier material, to control the timing of the fluid motion. The micro-separator has a simple structure, small size, without any moving component, and can easily integrate with other related micro-flow devices.

2. Description of the Related Art

In terms of micro-electronic device development, the major applications and fields that nanometer/micro-electronic technology applies to can be roughly classified into the bio micro-electromechanical system (Bio-MEMS), the radio frequency micro-electromechanical system (RF-MEMS), and the optical micro-electromechanical system (Optical-MEMS). With a series of biotechnological advances in animal cloning such as the cloning of sheep, cows and the like, the application of biotechnology in research is at the forefront of scientific development. In particular, the successful sequencing of human genes in the “Human genome project” has brought a new wave of research activities. In other words, there will be a market for biochemical product systems in the foreseeable future.

In the early 1990s, Andreas Manz, Jed Harrison and other scientists fabricated the first micro-chip with a miniaturized chemical analysis system. In comparison with traditional technology, the microchip has the advantage of analyzing samples in smaller quantities, at faster speeds and at a lower cost. Although the technology was originally applied to biological analysis, since then it also has been used in other areas such as classical chemical assays, environmental analysis and material measurements. Because in microchip technology, only a small quantity of a specimen is needed and the analysis is quick, more precise chemical reaction control can be achieved in terms of a faster and more accurate fluid injection, a better interfacing medium and a better reaction factor controllability. All these would be achieved with difficulties in a conventional reactor. Among these micro-devices, the microfluidic control system is a very important technique because it provides advantages such as small quantity inspection, automatic inspection, fast response, parallel-processing, disposable kit and the like. Therefore, a deeper investigation of microfluidics is the only way to develop more sophisticated, widely adopted fluid processing systems.

An ideal microfluidic system must have full analyzing capacity from the injection (including the storage and injection of the specimen) and the pre-processing (including concentration, mixing, dilution and reaction) of a specimen to its final analysis. Typically, the measurement of the fluid volume of a specimen ranges from microliter to picoliter. Because the fluid flow is very small, the fluid has to be transported using a special device. Nowadays, one common target of various research facilities around the world is to create a miniaturized analyzing laboratory by integrating various microfluidic devices such as micro-injector, micro-pump, micro-valve, micro-mixer and micro-reactor. In other words, the goal is to produce a micro testing and analysis system (μTAS) or lab on a chip design.

In terms of biological chips in the current market, the microfluidic technological platform in the chip is mainly based on an electro-kinetic driving mechanism such as an electro-osmosis system or an electro-phoresis system. They are considered the most mature products. The electro-kinetic driving technique has advantages and disadvantages described as follows.

The advantages:

1. It is easy to control the fluid.
2. It is easy to perform related biological processing such as molecular separation, mixing and flow control.
3. It is possible to fabricate a micro-separator on material such as glass, quartz or polymer.
   The disadvantages:
1. It is easily affected by the physical and chemical properties (such as ionic strength, PH value and the like) of the fluid.
2. Because a high voltage has to be used, the biological specimen is easily damaged.
3. It is only suitable for transporting a continuous fluid.
4. It can not transport a larger quantity of fluid (in excess of 1 microliter/second) on a wider channel.

Because of the aforesaid disadvantages of the electro-kinetic driving mechanism, a structure having a disk-like microfluidic processing platform has been developed. FIG. 1 is a diagram showing the main components of a conventional disk-like microfluidic processing platform. As shown in FIG. 1, the platform technique includes fabricating a micro-separator on a disk having a size similar to a conventional compact disk (CD). The technique relies solely on centrifugal force and thus requires no other forms of driving mechanism to move the fluid around. Hence, the micro-separator has a very simple structure if properly designed. This type of micro-separator includes advantages described in the following:
1. Low power and less space are required.
2. It is not sensitive to the physical and chemical properties of the fluid.
3. Air bubbles in the fluid are allowed.
4. It can be used for a wider range of channel widths and flow volumes (5 nl/sec-0.1 ml/sec). Moreover, it can be easily altered into a high density and parallel-processing design as required.
5. It can execute various mechanisms necessary for carrying out a biochemical analysis including separation, mixing, diversion, heating and volume-flowing control.

Obviously, the disk type microfluidic system has great potential for future development. Because the first step in most biochemical inspections is to separate a blood specimen into red blood cells and blood serum so as to use the blood serum to determine the type of possible diseases, the present invention provides a blood micro-separator on the aforementioned developmental platform.

### SUMMARY OF THE INVENTION

Accordingly, at least one objective of the present invention is to provide a micro-separator for blood separation into red blood cells and blood serum. The micro-separator is mainly used in a disk type microfluidic system. By means of centrifugal force, a micro quantity of blood is separated by the micro-separator. The micro-separator has no other moving components and occupies a relatively small volume. Furthermore, the micro-separator can integrate with other microfluidic devices and can avoid problems such as a blockage in the separating mechanism or a low operating efficiency.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing the main components of a conventional disk-like microfluidic processing platform.

FIG. 2 is a top view of a conventional blood separator.

FIGS. 3 to 6 are top views showing the processes for blood separation using the conventional blood separator of FIG. 2.

FIG. 7 is a top view of a second conventional blood separator.

FIGS. 8 to 12 are top views showing the processes for blood separation using the second conventional blood separator of FIG. 7.

FIG. 13 is a top view and a partially enlarged view of the micro-separator according to the present invention.

FIGS. 14 to 17 are top views showing the processes for blood separation using the blood separator according to the present invention.

### DESCRIPTION OF THE EMBODIMENTS

References are made in detail to the present embodiments of the invention, examples of which are illustrated in the accompanying drawings. Wherever possible, the same reference numbers are used in the drawings and the description to refer to the same or like parts.

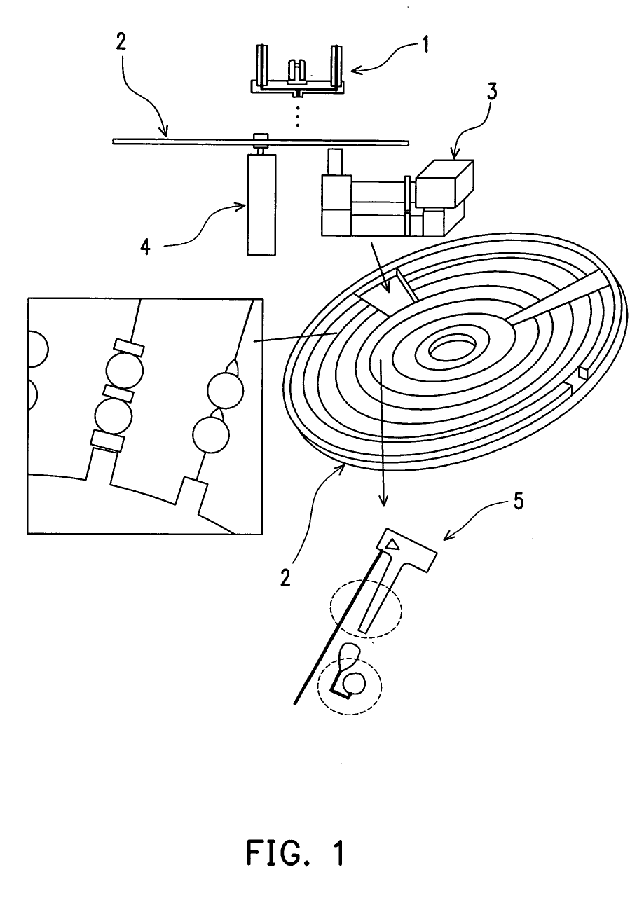

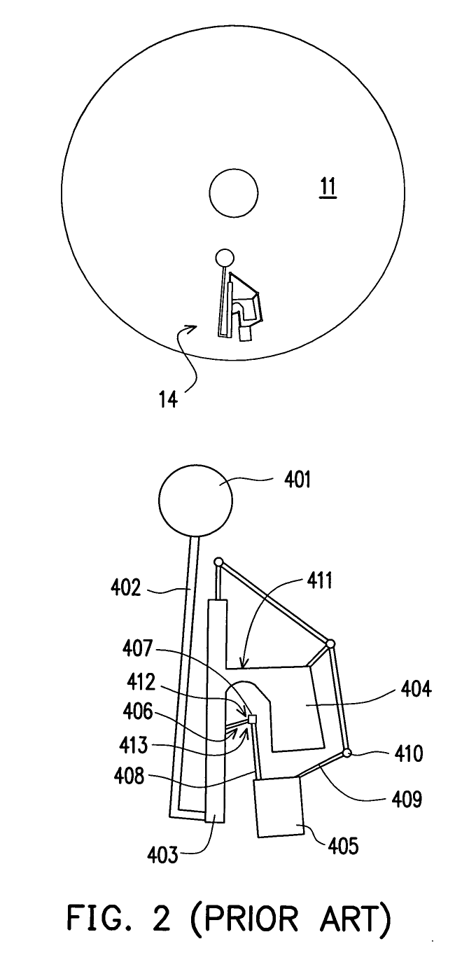

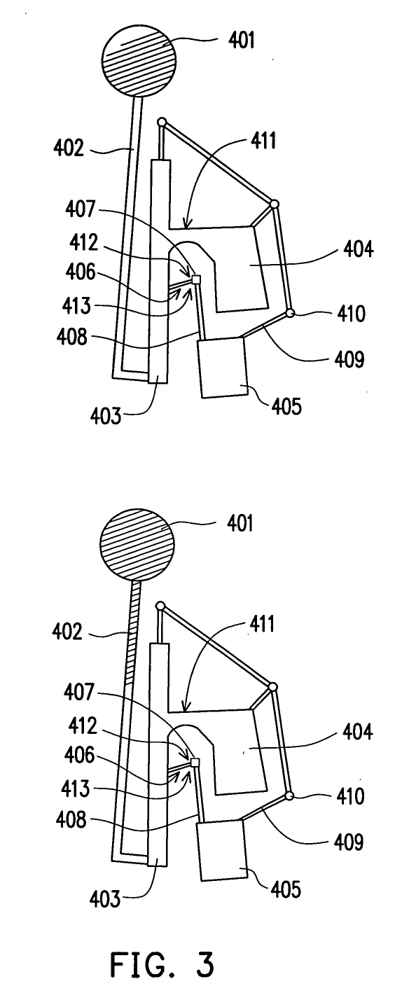

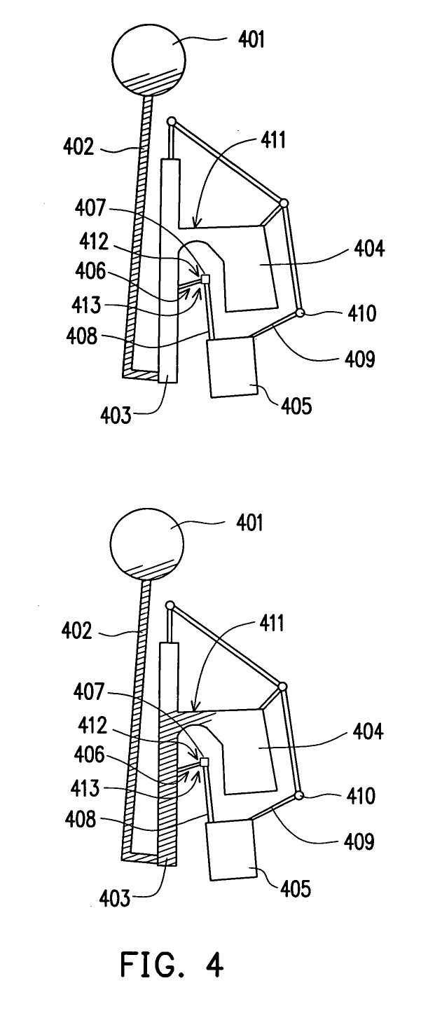

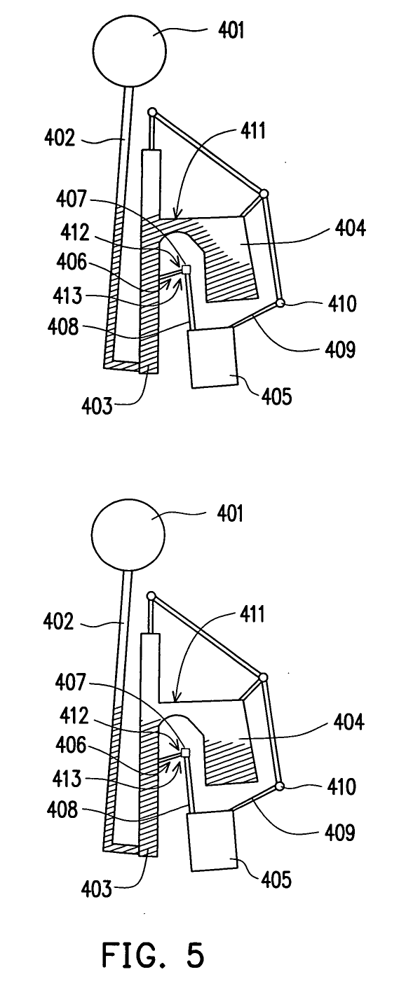

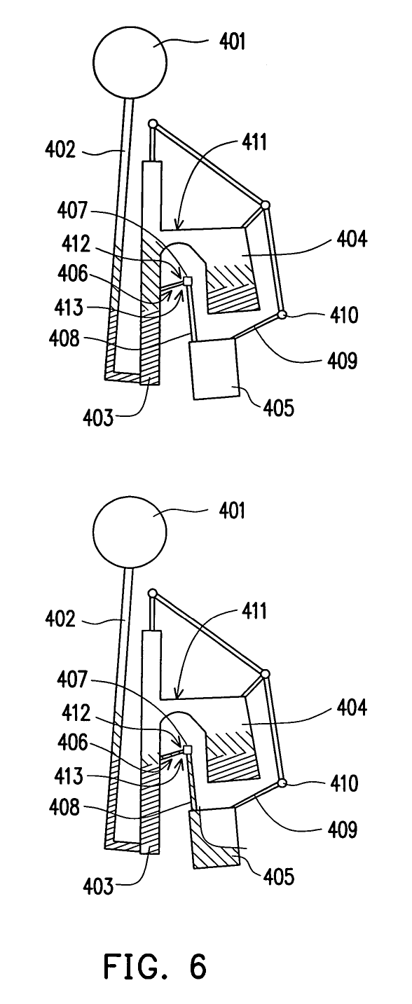

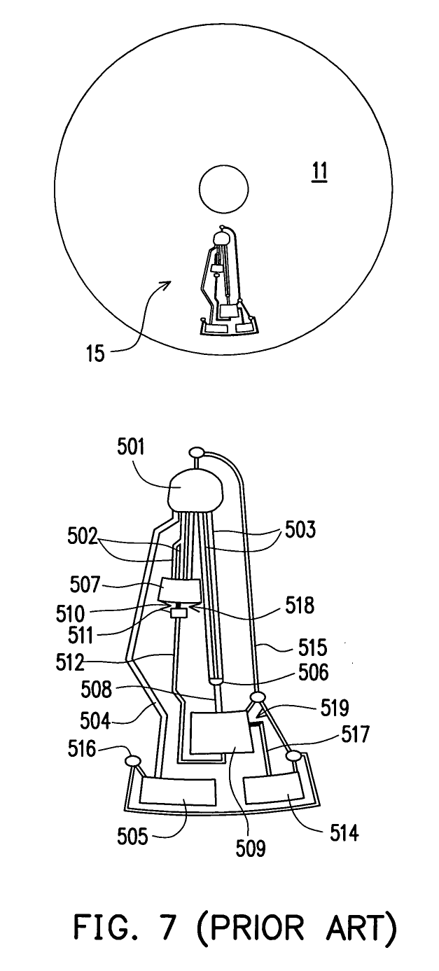

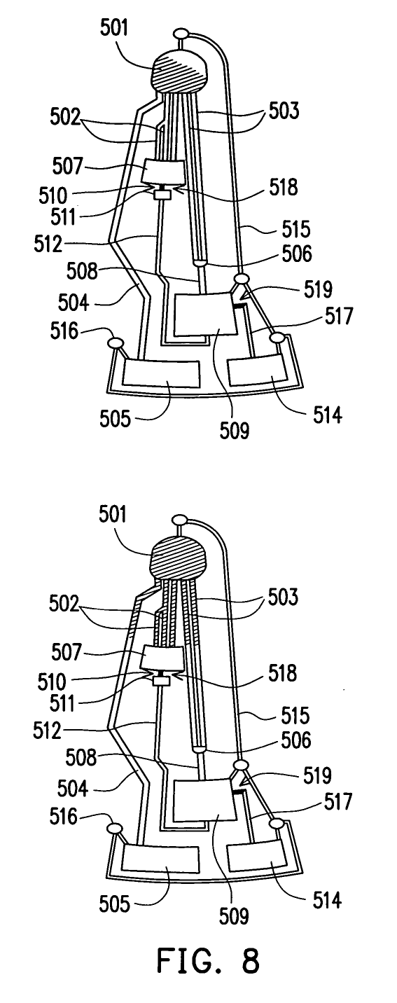

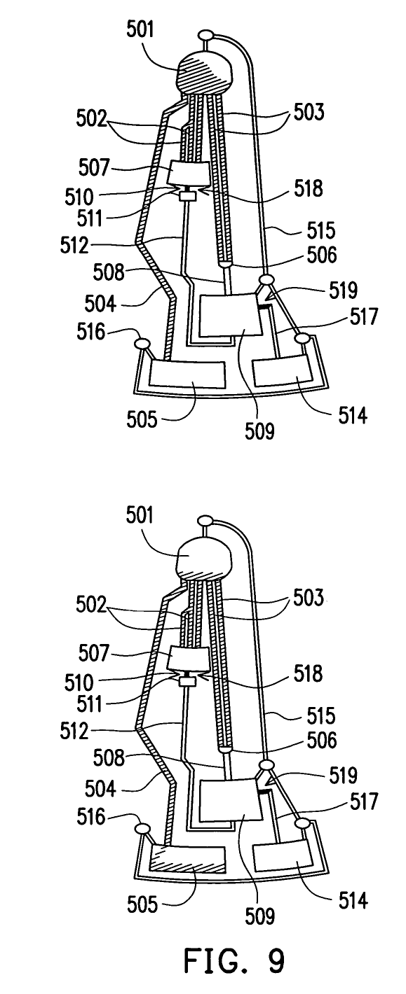

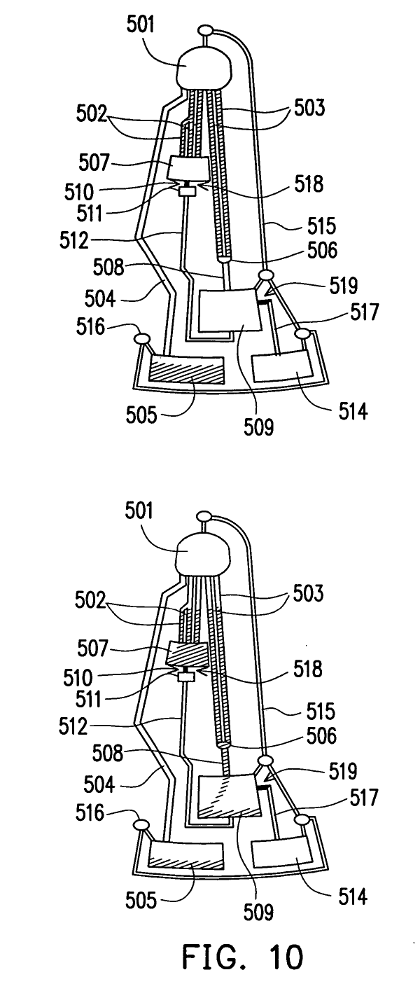

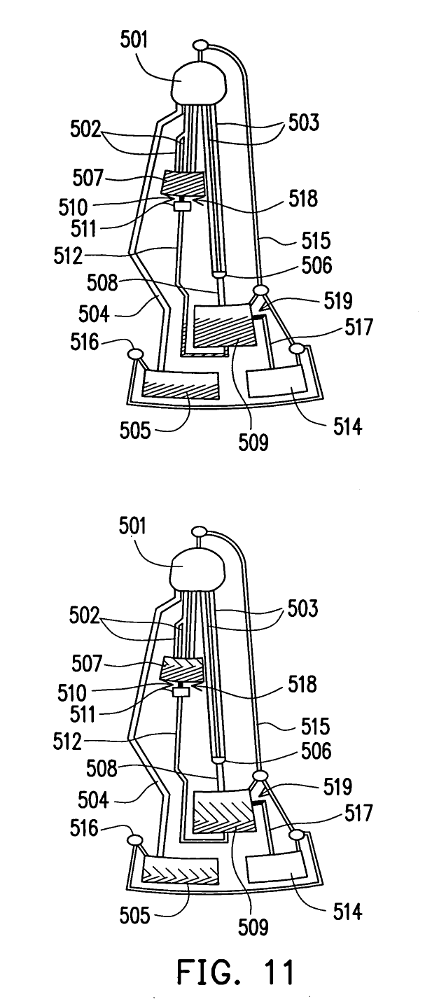

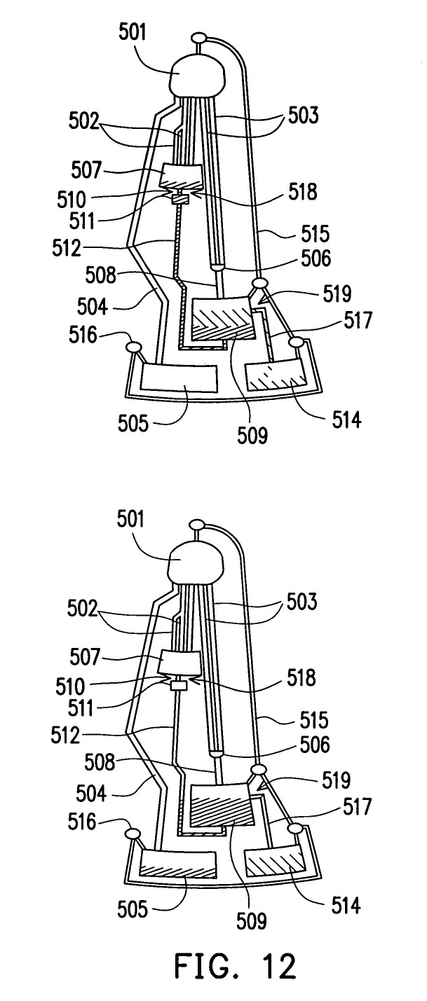

The research and development of disk-like biochemical detection techniques started in around 1990. However, a technological breakthrough was not made until one or two years ago. The leading manufacturers in this area include Gyros, a Swedish company, Tecan and Burstein, two American companies. From 1990 to 2001, the patents issued related to the microfluidic technique include the following: U.S. Pat. No. 4,940,527, U.S. Pat. No. 5,006,749, U.S. Pat. No. 5,061,381, U.S. Pat. No. 5,122,284, U.S. Pat. No. 5,171,695, U.S. Pat. No. 5,173,193, U.S. Pat. No. 5,173,262, U.S. Pat. No. 5,186,844, U.S. Pat. No. 5,242,606, U.S. Pat. No. 5,242,803, U.S. Pat. No. 5,252,294, U.S. Pat. No. 5,275,016, U.S. Pat. No. 5,304,348, U.S. Pat. No. 5,304,487, U.S. Pat. No. 5,336,181, U.S. Pat. No. 5,368,704, U.S. Pat. No. 5,403,415, U.S. Pat. No. 5,409,665, U.S. Pat. No. 5,413,732, U.S. Pat. No. 5,426,032, U.S. Pat. No. 5,431,303, U.S. Pat. No. 5,432,009, U.S. Pat. No. 5,457,063, U.S. Pat. No. 5,472,603, U.S. Pat. No. 5,478,750, U.S. Pat. No. 5,496,520, U.S. Pat. No. 5,518,930, U.S. Pat. No. 5,590,052, U.S. Pat. No. 5,591,643, U.S. Pat. No. 5,599,411, U.S. Pat. No. 5,624,597, U.S. Pat. No. 5,639,428, U.S. Pat. No. 5,693,233, U.S. Pat. No. 6,143,248, U.S. Pat. No. 6,302,134. Among the aforesaid patents, the content of U.S. Pat. No. 6,302,134 is most complete. It provides the description of two embodiments for blood separation. FIGS. 1 to 11 show the conditions for operating the blood separator in first and second embodiment. One common design in the two embodiments is that the serum storage well used for storing the serum separated from the blood is located far away from the center, near the disk rim. However, the application structure of this disk-type microfluidic system is subject to the limitation of the direction set by the centrifugal driving force. Basically, transporting fluid from a location further from the central rotational axis to a location closer to the central rotational axis is rather difficult. The difficulty of designing other devices for subsequent processing of serum is a first major problem in the conventional design.

A second problem in the conventional blood separator design of both embodiments is the use of a valve made from wax. The wax not only is difficult to process, but also needs a heating mechanism, so that the whole design structure becomes sophisticated and results in a higher production cost.

A third problem is related to the second embodiment of the blood separator. The blood separation process involves spinning the blood specimen to a speed high enough to separate the blood, and heating the wax to be melted to trigger the valve. Thereafter, the fluid inside the stabilizing well 507 is transported to the blood separation well 509 to raise the liquid surface level in order to separate the blood serum and store it in the storage well 514. A major problem can occur during the fluid-transportation process. That is the channel 512 is filled with air when the fluid inside the stabilizing well 507 is transported to the blood separation well 509. Yet, the fluid exists in both the upstream and downstream of the channel 512. When the air there between is compressed, unstable interfaces are created. Although the air can still enter the blood separation well 509 due to the compression from the upstream liquid at a high rotation speed f, the difficulties of control in the mechanism makes it hard to provide the precise control needed for integrating with an automatic controlling procedure in a future biochemical inspection device, and the high rotation speed f makes the design of lower-stream devices difficult.

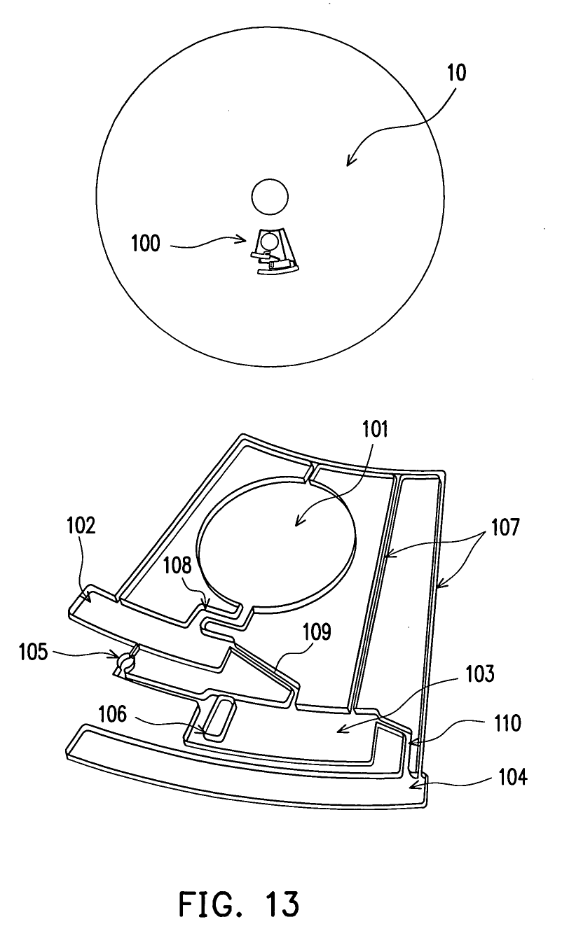

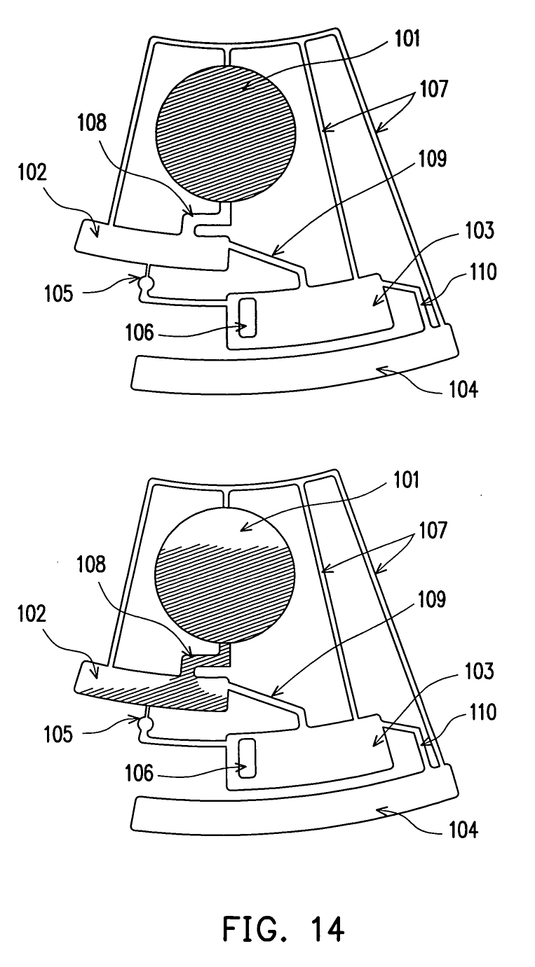

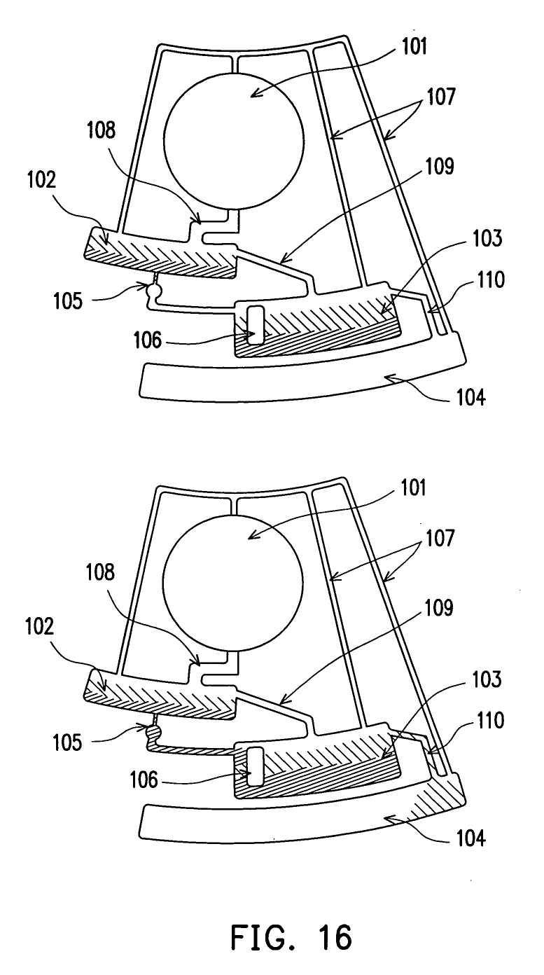

The present invention seeks to improve the aforesaid disadvantages. FIG. 13 is a top view of a micro-separator according to the present invention and a partially enlarged view of the micro-separator. As shown in FIG. 13, the substrate 10 is a compact disk (CD) like structure 12 cm in diameter. The present invention also applies surface tension to the valve design. To prevent capillarity, the substrate 10 is fabricated using hydrophobic material such as polydimethylsiloxane (PDMS) with a thickness of about 0.6 mm. The entire micro-separator structure 100, capable of holding one drop of blood of about 25 microliters, in order to avoid having an injection well with a large diameter so that the number of devices is not limited, the processed depth of the injection well is about 400 μm and its diameter is about 8 mm. FIGS. 14 to 17 are top views showing the processes of blood separation using the blood separator according to the present invention. In these figures, the portion in red color represents blood and red blood cells, and the portion in skin color represents blood serum. The operation of the micro-separator 100 is explained as follows.

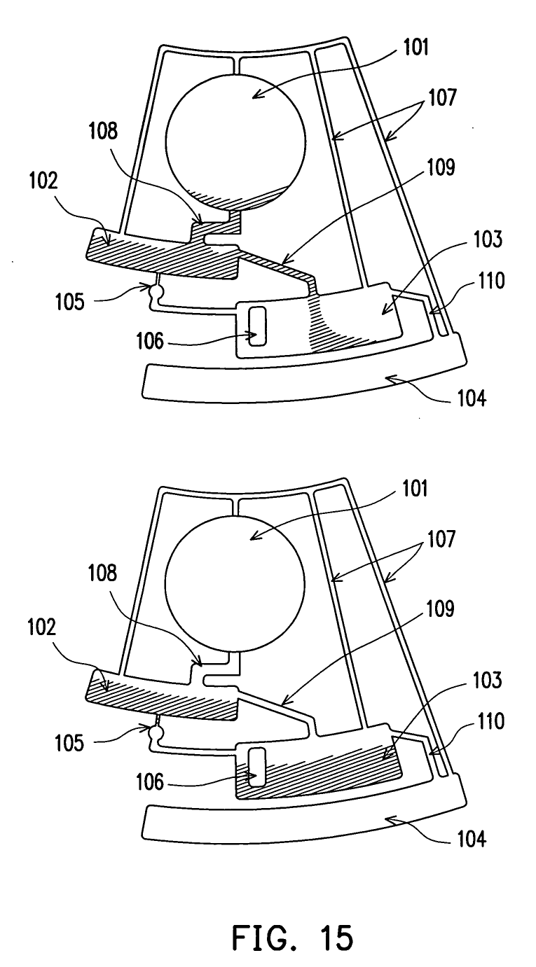

First, by a sophisticated manual injector or an automated robotic arm, a volume of about 20 microliters of blood is transported into the injection well through a top cover. Then, the disk starts to rotate. Because the width of the channel 108 is relatively large, a rotation speed of between 200 to 300 revolutions/per minute is set to make the blood flow into the auxiliary filling well 102. Because of the moderate rotation speed, the valve door 105 is not activated. After a few seconds, the liquid surface of the auxiliary filling well 102 rises above the entrance of the overflow channel 108, and the blood starts to flow into the blood separation well 103 as shown in FIG. 15. To produce the utmost separation effect and to prevent blood from flowing into the overflow channel 110, the dimensions of the auxiliary filling well and the blood separation well must be carefully computed and controlled to ensure the configuration shown in FIG. 15. In other words, the total blood volume in the auxiliary filling well and in the blood separation well must exactly match the total amount of blood injected so that the liquid surface almost reaches the inlet of the overflow channel.

Thereafter, the rotation speed is increased to about 1500 revolutions/per minute necessary for separating red blood cells from blood serum. At such a high rotation speed, the blood within the auxiliary filling well and the blood separation well starts to separate into a layer of red blood cells and a layer of blood serum. To ensure a complete separation, the high rotation speed of 1500 revolutions/per minute is continued for about 2˜3 minutes.

After that, the rotation speed is further increased to about 2000 revolution/per minute so that the valve 105 is activated to allow the liquid to flow from the auxiliary filling well into the blood separation well 103. The design of a barrier block 106 inside the blood separation well 103 prevents the injected liquid from breaking up the interface between the blood serum and the red blood cells. Moreover, the compressed air within the separation well 103 flows out through the gap above the barrier block to balance out the pressure. In a preferred embodiment, the amount of liquid injected is exactly enough to make the serum separated in the well 103 to completely flow out from the overflow channel 110.

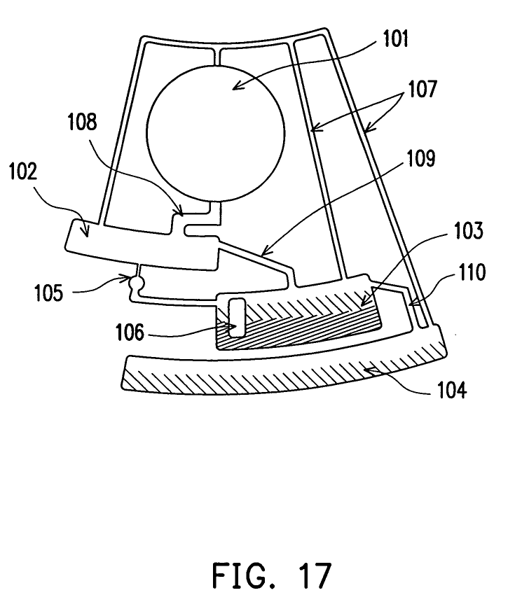

However, the volume of blood serum in human blood varies considerably, from 40% to 60% depending on the physiological state of each individual. To take this into account so that red blood cells are prevented from overflowing into the overflow channel 110, in the design the auxiliary filling well 102 must have a capacity to hold 40% of the blood volume in the blood separation well 103 (from liquid surface to the overflow channel inlet). After a further rotation for about ten seconds, the distribution of the fluid is shown in FIG. 17.

It is apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A blood micro-separator suitable for a disk-type biochemical analysis, comprising:
a blood injection well;
an auxiliary filling well;
a blood separation well;
a barrier block within the blood separation well; and
a valve and two overflow channels.

2. The micro-separator of claim 1, wherein the barrier block within the blood separation well can separate the separated red blood cells and blood serum from the liquid coming from the auxiliary filling well so that blood serum contamination can be prevented and the liquid from the filling well can be smoothly injected into the blood separation well.

3. The micro-separator of claim 1, wherein the barrier block inside the blood separation well has a small distance (about tens of micrometers) from the top ceiling to serve as an air vent for balancing out fluid pressure.

4. The micro-separator of claim 1, wherein the storage capacity of the auxiliary filling well and the blood separation well has to be calculated so the total volume of the auxiliary filling well and the blood separation well up to the liquid surface at the overflow channel inlet is equal to the volume of blood injected into the micro-separator, and the storage capacity of the auxiliary filling well is roughly 40% of that of the blood separation well.

5. The micro-separator of claim 1, wherein the separator comprises a valve to trigger a rotation speed higher than the speed necessary for separating the red blood cells from the blood serum in a blood specimen.

6. The micro-separator of claim 1, wherein the micro-separator is fabricated using a polydimethylsiloxane (PDMS) material or using a processed hydrophobic material.
